(19) United States
(12) Patent Application Publication
(10) Pub. No.: US 2025/0319469 A1
(43) Pub. Date: Oct. 16, 2025

(54) FRAME-SHAPED SPACER FOR PIPETTE TIP CARRIERS

(71) Applicant: Tecan Trading AG, Männedorf (CH)

(72) Inventor: Walter STEINHAUER, Männedorf (CH)

(73) Assignee: Tecan Trading AG, Männedorf (CH)

(21) Appl. No.: 19/083,199

(22) Filed: Mar. 18, 2025

(30) Foreign Application Priority Data
Apr. 11, 2024 (EP) 24169581.6

(51) Int. Cl. B01L 9/00

(52) U.S. Cl. CPC B01L 9/543; B01L 2200/025; B01L 2300/0809

(57) ABSTRACT

A frame-shaped rectangular spacer for a pipette tip carrier, configured to be stacked on top of another spacer thereby providing a vertical space between the spacers for carrier. The spacer includes a horizontal base surface, a peripheral side wall which stands essentially perpendicular to the base surface providing two longitudinal sides and two transverse sides connected to the base surface. The peripheral side wall includes an upper surface on an upper rim of the side wall and a lower surface on a lower rim of the side wall, and the upper surface of the peripheral side wall is configured to support the pipette tip carrier. The spacer includes load transfer elements configured to transfer a vertical load directly from one spacer to a subjacent spacer.

### CROSS REFERENCE TO RELATED APPLICATIONS

This application claims priority to European Patent Application EP24169581.6, filed Apr. 11, 2024, entitled “A FRAME-SHAPED SPACER FOR PIPETTE TIP CARRIERS”, which is incorporated by reference herein in their entirety and for all purposes.

### TECHNICAL FIELD

The current invention relates to a frame-shaped, essentially rectangular spacer for a rectangular pipette tip carrier, the spacer being configured to be stacked on top of another spacer thereby providing a vertical space between the spacers for the pipette tip carrier. An assembly including a stack of at least two spacers with the pipette tip carrier positioned between the two spacers and use of a spacer to create an alternating stack of spacers and pipette tip carriers.

### BACKGROUND

In analytical, biological or pharmaceutical laboratories, small liquid volumes are typically received and discharged using pipettes. Automated liquid handling platforms are frequently used for this purpose, which enable the aspirating and/or dispensing of liquid volumes with high precision and, nonetheless, high throughput rates for the liquids and samples. Such liquid handling platforms very often include pipetting robots, which are equipped with disposable or single-use pipette tips to avoid contamination between processing or sample liquids. Liquid handling platforms are typically charged with such disposable pipette tips, in that carrier plates or carrier trays equipped with pipette tips or even stacks of such carrier plates are provided. Such carrier plates typically include an array of pipette tips arranged in a standardized matrix so that a pipetting head of a pipetting robot can collect one or more of these pipette tips from a known position. Multichannel pipetting heads of the pipetting robot can collect one or more rows of pipettes or an array of pipettes from the carrier plate by coupling each of the pipetting heads to the pipettes in the carrier. The pipetting head pushes onto the pipette tips and thereby applies a vertical load onto the pipette carrier for elastically deforming a collar of the pipette tip or elastically deforming a rubber seal on the pipetting head. A friction fit engagement between the pipetting head and the collar of the pipette facilitates the pick-up of the pipette. The pipettes used by the robot for aspirating and dispensing liquids are disposed after use leading to an increased demand for disposable pipette tips which need to be stored within the pipetting robot. Space saving solutions have been developed for the storage of the disposable tips, for example by stacking multiple pipette tip carriers using spacers.

Carrier plates for disposable pipette tips and stacks of such carrier plates having inserted pipette tips for storing the tips are known from the prior art. EP2210668A2 discloses a storage system which includes a frame-shaped as a rectangular box and a rectangular pipette carrier plate having a plurality of holes arranged in a matrix for the insertion of pipette tips. The pipette carrier plate can be placed on top of the rectangular box such that the space in the box is available for the pipette tips extending through the holes of the carrier plate. Spacers are disclosed for providing an alternating stack including multiple pipette carrier plates each separated by a spacer. The spacer includes a rectangular frame surrounding a plate with passages arranged according to the same pattern as the holes in the pipette carrier plate, such that pipette tips inserted into a carrier are guided through the passages of the spacer. The end of the pipetting tips engaging the carrier fit into the openings of pipettes disposed on a subjacent carrier separated by the spacer. Using multiple carrier plates and multiple spacers leads to a space saving nesting of the pipette tips whereby the vertical load, for example during the collection of the pipette tips by the pipetting robot is repetitively transferred from a carrier to a spacer and finally to the work table of the pipetting robot via the rectangular box. The spacers and carriers require a certain wall thickness and mechanical strength for absorbing the vertical loads.

EP2848308B1 discloses a rectangular spacer for stacking rectangular pipette tip carriers on top of each other. The spacers are sandwiched between two carriers and vertical loads, for example during pick-up of the pipettes by the robot, are transferred in an alternating way from a carrier to a spacer. Each spacer includes two elastic elements in the vicinity of each corner which may be flexed by guiding surfaces of a subjacent pipette carrier when the spacer is placed onto the subjacent carrier. The elastic elements intend to reduce the horizontal play within a stack of multiple carriers and spacers. The vertical load during pick-up of the pipettes is transferred from the edges of the carrier to the spacers requiring a stiff construction of the carriers and the spacers.

EP 4190452A1 discloses a rectangular spacer for releasable stacking of rectangular pipette tip carriers. The spacers are sandwiched between two carriers and vertical loads are transferred from a carrier to a spacer in an alternating way. Each spacer includes an elastic element in the vicinity of each corner for reducing the horizontal play within a stack of multiple carriers and spacers.

### DESCRIPTION OF THE INVENTION

The alternating load transfer from a pipette carrier to a spacer requires that both the spacer and the pipette carrier need to be manufactured with low dimensional tolerances to reduce the stack-up of multiple tolerances that may affect effective transfer of vertical loads. Furthermore, the vertical loads are transferred to the spacer via the edges of the carriers only, therefore requiring a stiff and material demanding construction of the carrier.

It is an objective of the present disclosure to overcome the disadvantages of the prior art and to provide a spacer for pipette tip carriers stacked one on top of another, which provides improved stabilization of the carrier stack avoiding stack-up of multiple dimensional tolerances. A further objective is to provide assemblies of pipette carriers and spacers with an effective spacer-to-spacer load transfer which require less material or reduce the carbon footprint for the assembly.

Those objectives are solved by the independent claims, further exemplary embodiments are evident from the dependent claims and the following description including the Figures.

A first aspect relates to a frame-shaped essentially rectangular spacer for a rectangular pipette tip carrier, the spacer being configured to be stacked on top of another spacer thereby providing a vertical space between the spacers for the pipette tip carrier. Alternatively, the spacer may be stacked on top of a pipette box intended to be placed on a working table of the pipetting robot. The spacer includes a horizontal base surface connected to a peripheral side wall which stands essentially perpendicular to the base surface providing two longitudinal sides and two transverse sides. Each longitudinal side and each transverse side include an inner side or inner surface connected to the base surface. The peripheral side wall includes an upper surface arranged on an upper rim of the peripheral side wall and a lower surface arranged on a lower rim of the peripheral side wall. The upper and lower surfaces or rims extend essentially horizontally and are preferably arranged parallel to another. The upper surface of the peripheral side wall or at least a part of the upper rim is configured to support the pipette tip carrier. The spacer includes load transfer elements which are configured to transfer a vertical load directly from one spacer to a subjacent spacer. The vertical load may be applied to a pipette tip carrier positioned on the upper rim of the top spacer. The vertical load in a stack of alternating spacers and pipette tip carriers is subsequently transferred from spacer-to spacer without transferring the vertical load to one of the pipette tip carriers positioned between the spacers. Transferring the load from spacer-to-spacer via the load transfer elements without vertical forces transmitted to the pipette tip carriers implies that the stack-up of dimensional tolerances in a stack of multiple spacers and carriers is dominated by the manufacturing tolerances for the spacer as the pipette tip carrier is not vertically loaded. The manufacturing tolerances for the spacer therefore need to be tighter, or in other words, the dimensional precision for the pipette tip carrier may be less demanding compared to a stack of alternating spacers and carriers with a spacer-to-carrier loading. The mechanical strength of the pipette carrier may also be adjusted to the spacer-to-spacer loading principle such that wall thicknesses may be reduced leading to less use of for example polymeric material, thereby reducing the carbon footprint for the carrier and therewith the carbon footprint for a stack of carriers and spacers.

The load transfer elements on each spacer may include protrusions that vertically extend from the upper surface of the spacer, for example from each corner of the spacer. The spacer may include at least one protrusion vertically extending from the top surface, preferably include two protrusions, more preferably three protrusions and most preferably four protrusions. The protrusions may be located in the vicinity of the corners of the rectangular spacer or located at each corner. The protrusions may be oriented perpendicular to the horizontal base surface or may be angulated with respect to the horizontal base surface. The protrusions may be all oriented parallel to another or one or more of the protrusions is positioned at a different angle with respect to the horizontal base surface compared to the other protrusions. Each protrusion may have a hemi-spherical end surface, a sloped end surface, a cone shaped end surface or a surface that is essentially parallel to the horizontal base surface. Each protrusion may include a facet surrounding the end surface. The cross section for the protrusions may be circular for cylindrical protrusions or may be a rectangle, a triangle or an ellipse. The end surface of the protrusion is adapted to engage a stop surface on a superjacent spacer.

The stop surfaces may be recessed from the lower surface or lower rim of the spacer and may be positioned on one or on each corner of the spacer or may be positioned in the vicinity of one or each corner of the spacer. The stop surfaces may be complementary to the end surface of the protrusions of a subjacent spacer and may be flat, sloped or hemispherical.

The stop surfaces on each corner and the end surfaces on each protrusion of a spacer define a virtual plane and the plane connecting the end surfaces on the protrusions and the plane connecting the stop surfaces are preferably oriented parallel to another and preferably oriented parallel to the horizontal base surface.

The vertical loads may be finally transferred to the working table via the pipetting box. The last spacer may therefore abut an upper rim of the pipetting box.

In an embodiment, the protrusions vertically extending from the upper surface and the stop surfaces recessed from the lower surface may be essentially vertically aligned with respect to another. Alternatively, the protrusions and the stop surfaces are horizontally displaced with respect to another. The center of protrusions and stop surface may define an axis and the axis may be tilted or perpendicular with respect to the base surface of the spacer. The alignment of the protrusions and therewith the top surface of the protrusion and the stop surface ensures an effective vertical load transfer from spacer-to-spacer by the load transfer element.

The load transfer elements of the spacer engage the load transfer elements of a subjacent and/or a superjacent spacer in a stack of spacers. The stop surfaces recessed from the lower surface on each spacer are configured for abutting the end of the protrusions extending from a subjacent spacer. Each end of the protrusions extending from the upper surface on each spacer is configured for abutting the stop surfaces of a superjacent spacer.

The stop surfaces on the spacer may be part of a protrusion vertically extending from the horizontal base surface towards the lower rim. The protrusions or at least the stop surfaces on the protrusions are recessed with respect to the lower rim. The stop surfaces may be part of the peripheral side wall, for example be part of a horizontal flange located on the inside of the corner of the peripheral wall connecting the longitudinal side to the transverse side. Alternatively, the stop surface is located at the end of a rib protruding inwards from at least one corner, for example protrudes diagonally inwards.

The vertical distance between the upper rim and lower rim of the peripheral side wall is preferably below the length of the load transfer element defined by the vertical distance between the end of the protrusion vertically extending from the upper surface and the stop surface recessed from the lower surface. A vertical gap will be available for a pipette tip carrier when stacked between two spacers preventing vertical loading from one spacer to a subjacent spacer via the pipette tip carrier provided that the vertical dimension of the pipette tip carrier at the location of the peripheral side wall is below the vertical dimension of the gap.

The upper rim of the peripheral side wall may include ledges for holding and supporting the pipette tip carrier. The ledges may protrude upwards from the upper rim of the side wall. The ledges may engage complementary recessed sections in the bottom surface.

The load transfer elements on each spacer may further include protrusions extending vertically downwards from the lower rim of the peripheral side wall and the downward protrusions are configured to pass through complementary openings in a pipette tip carrier sandwiched between two spacers. The end surfaces of the downward protrusions are configured to abut the upper surface of the peripheral side wall of a subjacent spacer. The horizontal play between the protrusions vertically extending from the lower rim and the complementary openings in the carrier prevent vertical load transfer between the spacer and the carrier and ensure that a spacer can be removed from a stack independent from the pipette tip carrier.

The horizontal base surface of a spacer may include a projection located at the center of the rectangular spacer which protrudes vertically towards the upper rim of the peripheral side wall and protrudes towards the lower rim of the peripheral side wall and the top surface of the projection is configured to abut a pipette tip carrier positioned on top of the spacer and the bottom surface of the projection is configured to abut a pipette tip carrier positioned below the spacer during vertical loading. The projection is preferably coupled to the horizontal base surface and integrally formed with the rectangular spacer during, for example, injection molding. The projection may project vertically upwards and downwards from the horizontal base surface. Alternatively, the projection is a separate part and one part of the projection is snap fitted onto the center of the top surface of the base surface and the other part of the projection is snap fitted onto the center of the bottom surface of the base surface.

In a stack of alternating spacers and pipette tip carriers, the center projections may support the transfer of a vertical load from spacer to spacer via the center of the pipette tip carrier placed between two spacers. A vertical load may be applied by the pipetting head to the center of the pipette carrier during pick-up of the pipettes and this center load is transmitted to the subjacent spacer via the edges of the pipette tip carrier. The pipette tip carrier may bend towards the subjacent spacer and the center protrusion of that spacer may support the bottom surface of the pipette carrier. The center projection is preferably designed such that the projection towards the upper rim and the projection towards the lower rim do not contact the pipette trays in a resting position when no load is applied. Preferably, the end surfaces of the center projection do not extend beyond the upper rim and lower rim of the peripheral side wall. The projection may have a circular cross section, a rectangular cross section or may have an outer shape accommodated to an inner shape of a gripper of the pipetting robot facilitating gripping of the spacer. The projection projecting upwards from the center of the spacer may be configured to receive the projection projecting downwards from the center of a spacer placed on top of the spacer when no pipette tip carrier is placed between the spacers. The engagement of the center projections of the spacers may facilitate stacking of spacers for transport or handling purposes within the pipetting robot.

Alternatively, the projections in the center are located on the pipette tip carrier trays which are configured to engage openings in the center of the spacer. The projections protruding from the top of the carrier may abut or engage a protrusion protruding from the bottom of a superjacent carrier whereas the projections protruding from the bottom of the carrier may engage a projection protruding from the top surface of a carrier. The top and bottom engagements of the center projections pass through the center openings of the spacers placed between carriers.

The horizontal base surface of the spacer may include a plurality of openings oriented according to a pattern complementary to a pattern of pipette bores in the pipette tip carrier. The plurality of openings are preferably circular openings that intersect each other providing a shamrock-shaped opening. The openings provide space for the pipettes engaging a superjacent pipette carrier and the rims of the openings axially secure the pipettes engaging a subjacent spacer, for example during transport.

The horizontal base may further include ribs projecting from the top surface and/or the bottom surface of the horizontal base for mechanically strengthening the horizontal base surface of the spacer. The ribs may be placed between the plurality of openings and may be connected to the center projection discussed above. As an alternative, corrugated structures are included in the horizontal base surface or base layer.

In an embodiment, the spacer may include centering spring elements at each corner and the centering spring elements are configured to act upon the protrusions on each corner of a subjacent spacer on which the spacer is positioned with horizontal and/or vertical play thereby acting as a centering aid or as a twist barrier in a stack of the spacer and the subjacent spacer. The centering aid correct for the shifts in the horizontal plane. The twist barrier realigns a stack of spacers that has been twisted or torqued around the vertical axis of the stack.

The spring elements of a spacer act directly on a subjacent spacer and are not acting on the pipette tip carrier positioned between the spacer and the subjacent spacer. The centering aid provided by the spring elements or the twist barrier act from spacer-to-spacer without involving the pipette tip carrier such that the dimensional manufacturing tolerances for the carriers may be less tight. The spring elements are preferably located opposite to the protrusions vertically extending from the top surface and face towards the lower rim.

The centering spring elements at each corner of the spacer may at least partially surround the stop surfaces. The centering spring elements may surround the rib protruding inwards from the corner or the horizontal flange located on the inside of the corner.

The spring elements may be configured to at least partially surround the protrusions on each corner of a subjacent placed spacer. The spring elements may extend vertically wherein one end of the spring element is attached or attachable to the bottom of the horizontal base surface and the other end is configured to flex along the diagonal of the rectangular spacer or towards the center of the spacer. The spring element may be further mechanically supported by a fin extending from the bottom of the horizontal base surface and which may be coupled or adjacent to the spring element to reduce or adjust the degree of flexing of the spring element.

The spring elements may be shaped as half shells or at least the cross section of the spring elements may be shaped as a half shell, with a radius adapted to engage the outer radius of a cylindrically shaped protrusion of a subjacent spacer when the spacer is positioned on top of the subjacent spacer. During placement, the spring elements may be elastically deformed when engaging the protrusion of the subjacent spacer. The half shell may be positioned in the corner with the outer surface of the half shell facing the inner surface of the peripheral wall in the corner or the inner surface of the half shell faces the peripheral wall in the corner.

A second aspect relates to an assembly including a stack of at least two spacers and a rectangular pipette tip carrier positioned between the two spacers wherein the pipette tip carrier includes a plate including:
a lower surface for engaging the upper surface of a subjacent spacer,
a plurality of pipette bores for detachably holding pipette tips,
corner bores on each corner of the plate fitting onto the protrusions of the subjacent spacer,
openings providing a passage for the protrusions vertically extending from the lower rim of the peripheral side wall of a superjacent spacer, the end of the protrusions vertically extending from the lower rim are configured to abut the upper rim of the peripheral side wall of the subjacent spacer.

The lower surface of the plate or at least the lower surface in a rim section of the plate may engage the upper surface of the subjacent spacer or may engage the ledges protruding from the upper surface of the subjacent spacer. The openings in the plate or preferably in a rim section of the plate may be closed opening or may be provided as cut-outs in the rim of the plate.

A third aspect relates to the use of at least one spacer according to claims wherein stacks of pipette tip carriers provided with pipette tips which are spaced apart by means of the spacers are produced. The stacks are alternating stacks of pipette tip carriers and spacers.

These and other aspects of the disclosure will be apparent from and elucidated with reference to the embodiments described hereafter.

### BRIEF DESCRIPTION OF THE DRAWINGS

Embodiments of the present disclosure are described in more detail with reference to the attached drawings presenting:

FIG. 1: Perspective view from the top for a pipette tip carrier according to the present disclosure,

FIG. 2: Perspective view from the bottom for a pipette tip carrier according to the present disclosure,

FIG. 2a: Bottom view for a pipette tip carrier according to another embodiment,

FIG. 3: Detail of a corner section of the pipette tip carrier holding pipettes and a gripper of a pipetting robot,

FIG. 4a: Detail for a thin rectangular skirt section of the pipetting carrier allowing for pick-up of the first row of pipetting tips using the pipetting robot,

FIG. 4b: Detail for a medium thickness rectangular skirt section of the pipetting carrier allowing for pick-up for the first row of pipetting tips using the pipetting robot,

FIG. 4c: Detail for a high thickness rectangular skirt section of the pipetting carrier preventing pick-up of the first row of pipetting tips using the pipetting robot due to a collision of the collar adapter of a pipetting head with the skirt before pick-up of the pipette tips,

FIG. 4d: Detail for thin rectangular skirt section of the pipetting carrier allowing missing tip detection in the carrier,

FIG. 4e: Detail for rectangular skirt section of the pipetting carrier not allowing detection of missing tip due to a hard stop of the collar adapter on the skirt of the carrier,

FIG. 5: Packaging for the pipette tip carrier presented in FIGS. 1 and 2 in an unfolded configuration,

FIG. 6: Folded packaging for the pipette tip carrier presented in FIGS. 1 and 2,

FIG. 7: Packaging holding two pipette tip carriers,

FIG. 8: Longitudinal section of the packaging presented in FIG. 7,

FIG. 9: Perspective top view for a spacer for the pipette tip carrier presented in FIGS. 1 and 2,

FIG. 10: Perspective bottom view for a spacer for the pipette tip carrier,

FIG. 11: Exploded view of two spacers with three pipette tip carrier positioned there between,

FIG. 12: Stack of pipette tip carriers and spacers,

FIG. 13: Longitudinal section of the stack of FIG. 12,

FIG. 14: Detail for the corner section of the stack,

FIG. 15: Detail for spacer-to-spacer stacking via spacer protrusions and openings in the longitudinal skirt section of the pipette tip carrier,

FIG. 16: Detail for the corner section, cross sectional view.

### DETAILED DESCRIPTION OF EXEMPLARY EMBODIMENTS

Definitions: The distal end or distal direction is defined by the flow direction for the liquid, thus the distal tip of a pipette is defined by the outlet of the pipette tip and the proximal end is opposite to the distal end. The term subjacent means underlying or below; the term superjacent means lying above or on-top. In the claims, the word “comprising” does not exclude other elements or steps, and the indefinite article “a” or “an” does not exclude a plurality. For example, “an opening” does not exclude the fact that there may be two openings that functionally or structurally fulfill the purpose of “an opening”.

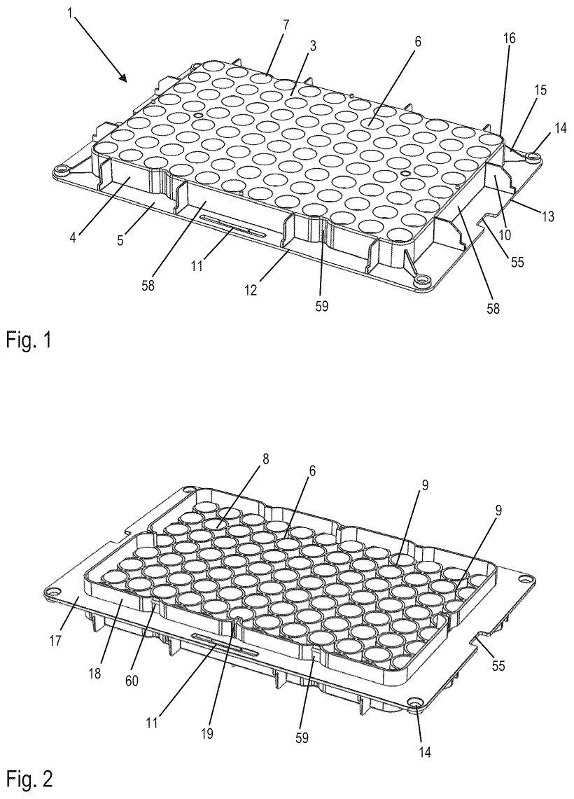

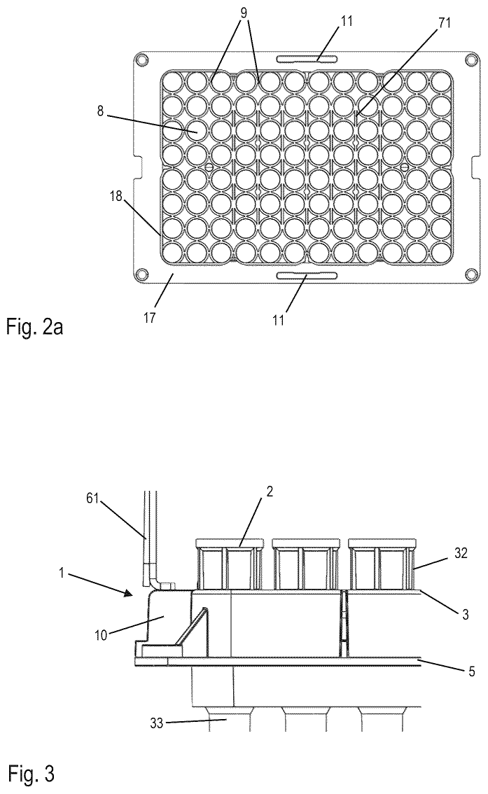

Perspective top and bottom views for a pipette tip carrier 1 according to an embodiment of the present disclosure are presented in FIGS. 1 and 2, respectively. The pipette tip carrier 1 has a rectangular outer shape with a rectangular shaped top plate 3 surrounded by a peripheral wall 4 which connects the top plate 3 to a rectangular skirt 5. The top plate 3 defines a horizontal plane and the rectangular skirt 5 is oriented horizontal as well. The top plate 3 includes a plurality of circular openings 7 which are organized in a matrix of rows and columns according to ANSI/SLAS Microplate Standards, for example according to the 96 well-plate standard (ANSI SLAS 4-2004 (R2012): Well Positions). Hollow cylinders 6 depend from, or start at the circular openings 7 providing a matrix of passages 8 through the pipette tip carrier 1. The pipette tip carrier may releasably hold disposable pipette tips 2 using the passages 8 (see FIG. 3). The peripheral wall 4 may include a labelling section 58 for printing information such as the brand name or a two- or three-dimensional barcodes for identification or logistic purposes. The peripheral wall 4 may further include indentions 59. The rectangular skirt 5 includes a longitudinal side 12 and a transverse side 13 and is relative thin for a material saving product. The thickness of the skirt is below 3 mm, preferably below 2 mm, more preferably below 1.5 mm. The relatively thin rectangular skirt 5 is strengthened by a plurality of rim ribs 10 connecting the top surface of the rectangular skirt 5 to the peripheral wall 4. The rim ribs 10 furthermore provide guidance to and limit the horizontal play for a lid that may be placed on top of the pipette tip carrier 1. The top surface of the rim ribs 10 may be used for mechanically detecting the presence of the pipette tip carrier by a gripper of a pipetting robot. The space between two rim ribs 10 on the peripheral wall or on the top surface of the skirt 5 may provide for the labelling section 58. The rectangular skirt 5 includes openings 14 at each corner of the pipette tip carrier which are adapted to engage complementary protrusions of a spacer that will be placed below the pipette tip carrier as will be discussed further below. Alternatively, the openings 14 engage protrusions of a pipetting box that is fixated on the working table of the pipetting robot. A circular rim may surround each opening 14 providing an entrance section, for example a facetted rim, for guiding the protrusions during stacking of the spacers and the pipette tip carriers. The circular rim may further locally strengthen the rectangular skirt 5 in the corner section. The openings 14 may be dimensioned that there is horizontal play between the opening 14 and the protrusion of the spacer or there may be a friction fit engagement between the outer surface of the protrusion and the inner surface of the opening 14. The form-fit engagement may enable the temporary transport of an assembly of a spacer and a carrier via gripping the carrier only. Preferably, only the spacer is gripped by the pipetting robot, either in a form fit or friction fit engagement.

A corner rib 15 may connect the opening 14 or the circular rim surrounding the opening 14 to the peripheral wall 4, preferably to the corner 16 of the peripheral wall. The rectangular skirt 5 may further include at least one opening 11, preferably two openings 11 penetrating the two longitudinal sides 12 or the two transverse side 13 of the skirt. The opening 11 may have a rectangular, circular or triangular shape and provide a passage for a complementary protrusion of a superjacent spacer. The corners of the opening may be rounded and the edges of the opening may include a facet. The opening 11 may be surrounded by a rim for mechanically supporting the rectangular skirt 5 surrounding the opening 11. The rectangular skirt 5 may include a cut out 55 providing a passage for a protrusion of a superjacent spacer.

The pipette tip carrier 1 may include a bottom wall 18 vertically extending from the bottom surface 17 of the rectangular skirt 5. The bottom wall 18 surrounds the matrix of the passages 8 and the ends of the cylinders 6 providing the passages 8 are preferably even or flush with the bottom surface 17 of the rectangular skirt 5. Alternatively, the cylinders penetrate beyond the bottom surface 17 although further extension of the cylinders beyond the bottom surface 17 may lead to unnecessary use of material. The further extension of the cylinders may mechanically reinforce the pipette tip carrier. The cylinders 6 may be directly connected to neighboring cylinders by connecting ribs 9 to mechanically strengthen the pipette tip carrier. The cylinders 6 may also intersect to neighboring cylinders without using the connecting ribs 9 and the cylinders 6 may be connected to an inner surface of the peripheral wall 4 by connecting ribs or, as presented in FIG. 2, the cylinders may intersect with the inner surface of the peripheral wall 4. The thickness of the ribs may vary depending on the position within the pipette tip carrier according to the local needs defined by the mechanical stresses in the carrier upon vertical loading. The ribs 9 may be thicker in the center of the carrier compared to the ribs in the outer regions towards the skirt 5.

The indentions 59 on the bottom wall 18 of the carrier may include horizontal ridges 60 that may act as a vertical place holder for stacking multiple carriers or may provide a snap-fit connector between two carriers or between a carrier and a patent box. The guiding member 19 on the bottom wall 18 may be used for self-alignment purposes or gripping purposed. The indentions 59 and/or the guiding members 19 may locally strengthen the bottom wall 18.

An alternative embodiment for the pipette tip carrier is presented in FIG. 2a. The view on the bottom surface 17 presents the two openings 11 in the skirt of the carrier and the bottom wall 18 penetrating from the bottom surface 17. The plurality of passages 8 for the pipette tips are surrounded by the cylinders which are connected to another by connecting ribs 9. The embodiment presented in FIG. 2a is additionally mechanically supported by reinforcement ribs 71 connecting two connecting ribs 9 to another providing vertically oriented reinforcement ribs. The reinforcement ribs 71 are vertically oriented in FIG. 2a and oriented parallel to the transverse side of the pipette tip carrier. Alternatively, the reinforcement ribs are horizontally oriented parallel to the longitudinal side of the pipette tip carrier. In yet another embodiment there are both horizontally and vertically oriented reinforcement ribs 71.

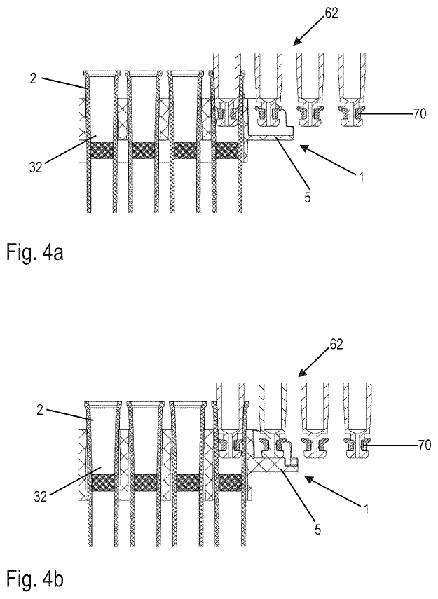

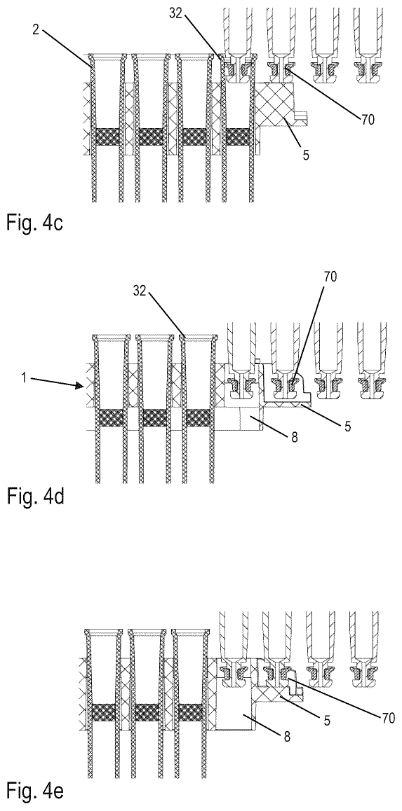

A detail of a corner section of the pipette tip carrier 1 holding pipettes 2 is presented in FIG. 3. The pipettes 2 include a collar 32 engaging the top plate 3 of the carrier and pipette tubes 33 extending from the collar 32 through the passages. A gripper 61 of a pipetting robot abuts the top surface of a rim rib 10, for example to mechanically detect if a tray is present or not. The pipetting robot may include a pipetting head 62 for collecting the pipetting tips 2, see FIGS. 4a to 4e. The thickness and position of the rectangular skirt 5 defines the height of the peripheral wall 4 this may affect the accessibility for the pick-up of single rows from the matrix of pipetting tips in the carrier (see FIGS. 4a to 4c) or the detection of a missing row of pipette tips (see FIGS. 4d and 4e). The pipetting head 62 includes multiple collar adapters 70 which are lowered towards the collars 32 of the pipettes 2 by the pipetting robot for pick-up of the pipettes. The approach is halted when the collar adapters 70 of the pipetting head abut a mechanical stop such as the rectangular skirt 5 of the carrier 1 and a thin rectangular skirt 5 (FIGS. 4a and 4b) may provide sufficient access to the pipettes in the carrier for pick-up of a single row of pipettes while the adjacent collar adapters 70 do not contact the skirt 5 surrounding the carrier. If a hard stop is detected by the pipetting robot before effective pick-up of the pipettes from the carrier, then the pick-up of the tips may be jeopardized or the pick-up of the rows may damage the hardware of the pipetting robot, see FIG. 4c where thickness of the skirt 5 affects that the collar adapter 70 abuts the skirt 5 before the adjacent collar adapter 70 can catch the pipette tip 2 from the first row. The thickness of the rectangular skirt 5 may also affect the detection of a missing row of pipettes in the pipette tip carrier. FIG. 4d presents a pipette tip carrier 1 with a missing first row of pipettes 2 and the firmware of the pipetting robot can detect the missing row as the vertical position of the pipetting head 62 with the collar adapters 70 would normally detect an increase in vertical force required for the pick-up of the pipettes as the collar adapters 70 may need to elastically deform the rim of the pipette collar 32. The collar adapter that is adjacent to the collar adapter entering the passage 8 of the pipette carrier 1 does not abut the thin-walled rectangular skirt 5. A circumferential skirt 5 with a higher thickness as presented in FIG. 4e would result in a hard stop of the collar adapter 70 adjacent to the collar adapter entering the first row of passages 8 and the hard stop on the skirt would be detected before the firmware of the pipetting robot can detect the missing row. A thin-walled circumferential skirt 5 may therefore provide a versatile solution when used in a pipetting robot.

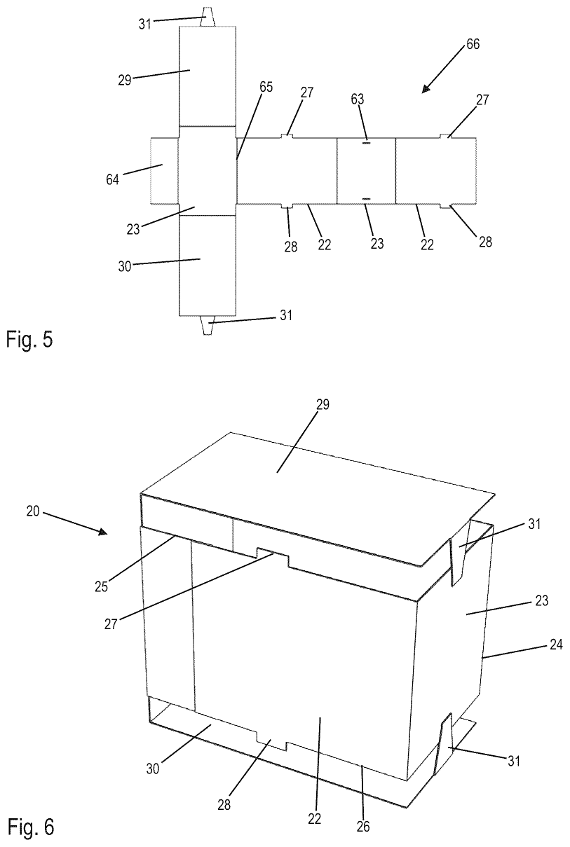

An example for a packaging 20 for the pipette tip carriers is presented in FIGS. 5 to 8. The packaging 20 is based on a foldable sheet 66 that is punched from a plate of a material such as cardboard, coated cardboard, plastic or a composite material. The foldable sheet 66 includes two longitudinal sides 22 connected by a transverse side 23. The longitudinal sides 22 each include two protrusions or flaps, a flap or protrusion 27 and a flap or protrusion 28 which, after the sheet 66 has been folded into a rectangular shaped box 24, extend from a top rim 25 and a bottom rim 26 of the packaging 20 (see FIG. 6). A top cover 29 and a bottom cover 30 is attached to one of the two transverse sides 23 and closure lids or closure flaps extend from the top cover and bottom cover respectively. Closure slits 63 are included in the other one of the two transverse sides 23 configured for engaging the closure lids 31. A closure flap 64 is attached to one of the transverse sides 23 for closing the rectangular box 24. Fold lines or predetermined folds are integrated in the foldable sheet 66, for example perforation lines or cutting lines 65 may be integrated in the foldable sheet 66. The two protrusions or flaps 27 or 28 may include barbed hooks for releasably fixating the pipette tip carrier to the packaging.

The sheet 66 may be folded in a rectangular shaped box 24 as presented in FIG. 6 providing the folded packaging 20. A top rim 25 and bottom rim 26 extend from the upper surface and lower surface of the longitudinal sides 22 and transverse sides 23 thereby providing a top opening and bottom opening that is accessible for insertion of two pipette tip carriers 1. The top and bottom openings are surrounded by the top rim and bottom rim, respectively. The protrusions or flaps 27, 28 extend from the top rim 25 and bottom rim 26, respectively. The top cover 29 and bottom cover 30 can be bent from a vertical orientation allowing access for the carriers towards the top and bottom rim for closing the packaging.

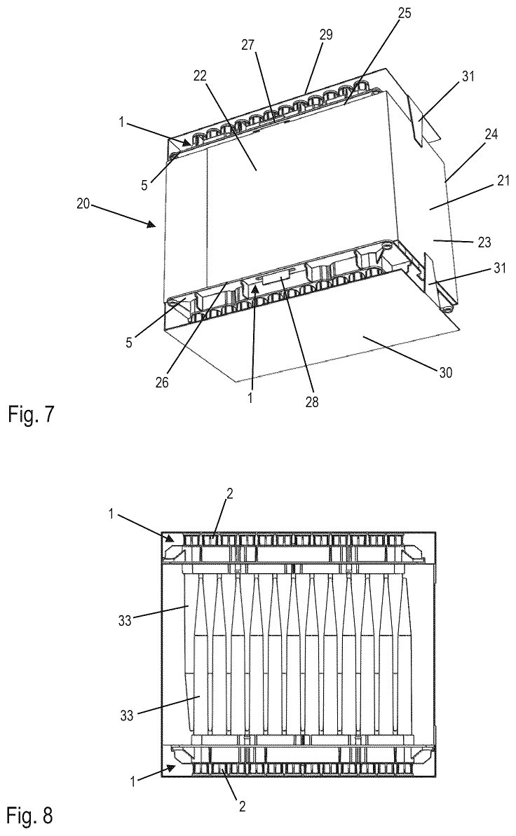

An assembly including the packaging 20 and two pipette tip carriers 1 is shown in FIG. 7. The two carriers 1 are each inserted with their respective bottom surfaces 17 of the skirt 5 facing towards the top rim 25 and bottom rim 26 of the packaging 20. The pipette tubes 33 that are releasably connected to the two pipette tip carriers are enclosed within the rectangular box 24 and the two flaps 27 extending from the top rim 25 engage the openings 11 of one of the two pipette tip carriers. The two flaps 28 extending from the bottom rim 26 engage the two openings 11 of the other one of the two pipette tip carriers. The optional barbed hooks on the flaps may provide a temporary fixation of the carrier to the packaging. The bottom surface 17 on the rectangular skirt 5 of each pipette tip carrier is supported by the top and bottom rim 25, 26 of the rectangular box 24 and the engagement between the protrusions 27, 28 and the openings 11 may prevent dislodgement between the rectangular skirt 5 of the carriers and the rectangular box 24. The packaging 20 is closed by folding the top cover 29 and bottom cover 30 such that the covers are aligned with the horizontal plane of the pipette tip carriers. The closure lids 31 are attached to transverse side 23 of the packaging using slits 63 (see FIG. 5). A longitudinal section through the packaging filled with two pipette tip carriers holding pipette tips is shown in FIG. 8. The pipette tubes 33 of each carrier are intermeshing for a space saving arrangement of the pipette tips 2. The two pipette tip carriers 1 may be removed from each side of the box after opening the closure lids 31 and tilting the top cover 29 and bottom cover 30 towards a vertical position.

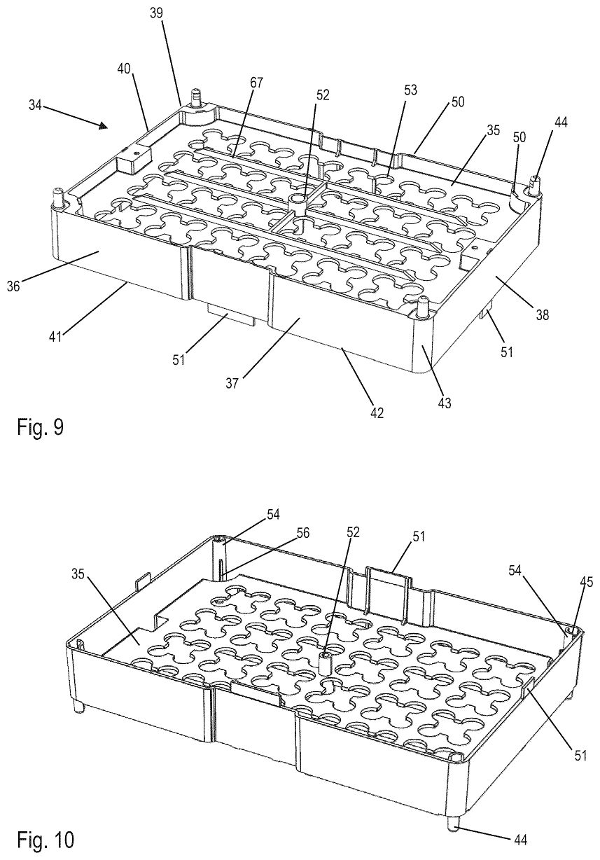

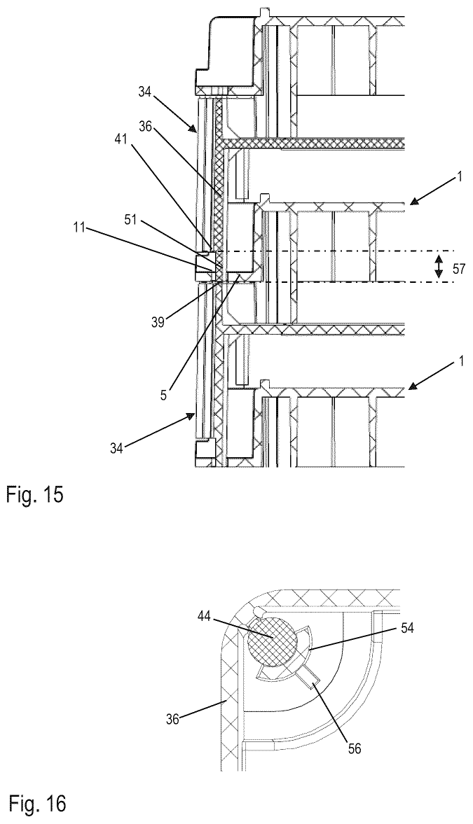

A rectangular shaped spacer 34 for stacking pipette tip carriers is presented in FIGS. 9 and 10. The spacer 34 includes a horizontal base surface 35 surrounded by a peripheral side wall 36 oriented essentially vertical with respect to the base surface 35. The base surface 35 includes semi-circular openings 53 with centers oriented to the same pattern as passages 8 in the pipette tip carrier. The semi-circular openings may intersect leading to a plurality of shamrock-shaped openings. The openings provide a passage for the pipetting tubes 33 of pipetting tips 2 engaging a pipette tip carrier positioned on top of the spacer 34 and prevent dislodgement of the collars 33 from a pipette tip carrier positioned below the spacer 34. The horizontal base surface 35 is strengthened with corrugated structures 67 such that material is added to the base surface where mechanically needed. The peripheral side wall 36 includes two longitudinal sides 37 and two transverse sides 38 providing an upper rim 40 and lower rim 42 which are oriented parallel to another. Ledges 50 project upwards from an upper surface 39 of the upper rim and protrusions 51 project downwards from a lower surface 41 of the lower rim 42. Protrusions 44 protrude upwards from the upper surface 39 in each corner of the rectangular shaped spacer 34. A projection 52 protrudes from the center of the rectangular shaped spacer 34 towards the upper rim 40 (FIG. 9) and protrudes from the center towards the lower rim 42 as well (FIG. 10). Load transfer elements 43 are located on each corner of the rectangular shaped spacer 34 which include the protrusion 44 and stop surfaces 45. Optionally, there are additional load transfer elements located between the corners of the spacer. Further details for the load transfer elements will be explained in FIGS. 14 and 15. The perspective bottom view in FIG. 10 further presents spring elements 54 that surround the stop surfaces 45 in each corner and the spring elements 54 are connected to the bottom surface of the horizontal base surface 35 and the free end of the spring element 54 may flex towards the center or towards the corner of the rectangular shaped spacer 34. The spring element 54 may be mechanically supported by a support rib 56 that protrudes from the bottom surface of the base 35. The load transfer elements 43 provide for the transfer of a vertical load from a spacer to a subjacent spacer whereas the spring elements 54 provide for a correct spacer-to-spacer alignment in a stack of spacers.

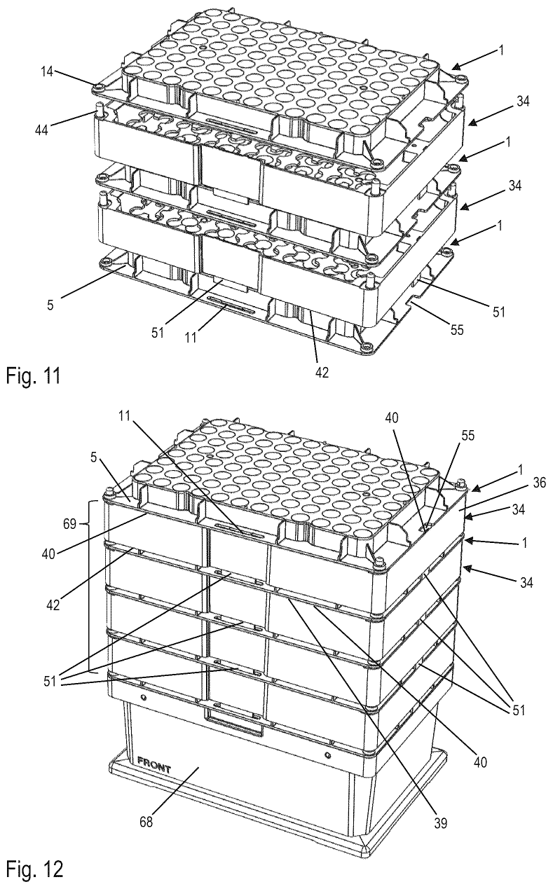

An exploded view of a stack of alternating spacers 34 and pipette tip carriers 1 is depicted in FIG. 11. Each pipette tip carrier 1 is positioned with the openings 14 on each corner onto the protrusions 44 on each corner of a subjacent spacer. The protrusions 51 protruding from the lower rim 42 of each spacer 34 are aligned with the cut outs 55 and the openings 11 in the rectangular skirt 5 of each pipette tip carrier 1 such that the openings 11 provide a passage for the protrusions, preferably without contacting or abutting the protrusions 51 thereby avoiding vertical load transfer from a spacer 34 to a pipette tip carrier 1 positioned below the spacer. The play in the horizontal plane between the protrusions 51 on the spacers and the cut outs 55 or the openings 11 on the carriers is sufficient to avoid direct contact.

The stacked pile 69 of spacers 34 and carriers 1 is shown in FIG. 12. The stack is placed on top of a pipette box 68 releasably holding the stack such that the stack or part of the stack may be removed by a gripper of a pipetting robot. The pipette box 68 may be fixated on a working table of the pipetting robot. Each pipette tip carrier 1 is placed on the upper surface 39 of the upper rim 40 of a subjacent spacer. Optionally, the carrier is supported by the ledges 50. The protrusions 51 protruding downwards from the lower rim of each spacer abut the upper surface 39 of a subjacent spacer either via the cut-outs 55 or via the openings 11 in the rectangular skirt 5 of each pipette tip carrier 1. The pipette tip carriers 1 are within a vertical space or gap between two spacers 34 and the vertical load applied to the pipette tip carrier 1 on top of the pile is transferred via the rectangular skirt 5 to the upper rim 40 of the first spacer 34 and the vertical load is subsequently transferred to the second spacer 34 via the load transfer elements 43 on each corner of the first spacer and/or via the protrusions 51 extending from the lower rim of the first spacer. The vertical load is finally transmitted to the worktable of the pipetting robot via the pipetting box 68. Details for the load transfer via the load transfer elements 43 are presented in FIG. 14 and details for the load transfer via the protrusions 51 are presented in FIG. 15.

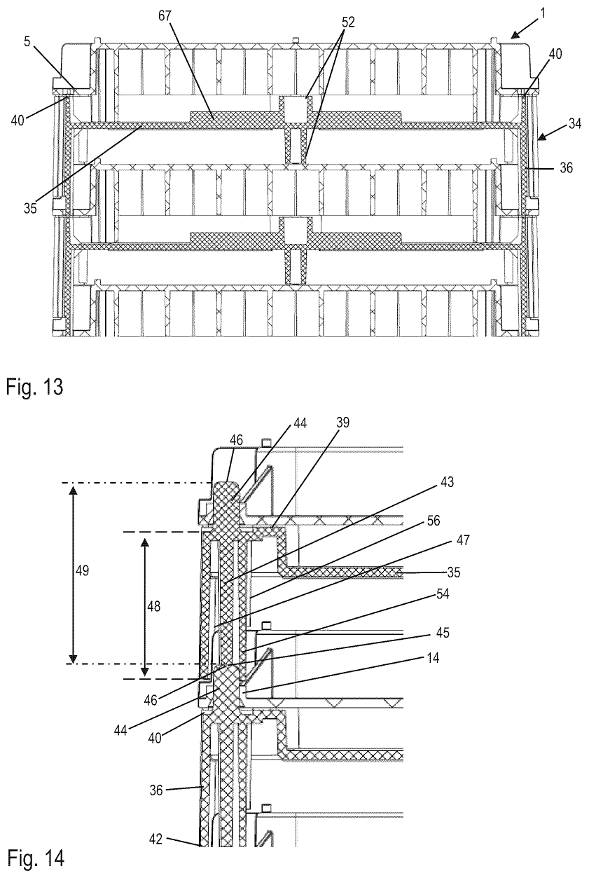

A longitudinal section for the stack is depicted in FIG. 13. The vertical load from the pipette tip carrier 1 on the top is transmitted via the rectangular skirt 5 to the upper rim 40 of the first spacer 34. The first spacer 34 includes the base surface 35 surrounded by the peripheral side wall 36 and the base surface 35 is strengthened by the corrugated structures 67 (see also FIG. 9). In case the pipette carrier 34 on top flexes or bends due to the vertical load, then the projections 52, which do not contact the subjacent or superjacent pipette tip carriers in a resting position, may additionally absorb the vertical loads thereby transferring a minor part of the load in the center from the pipette tip carrier on the top to the first spacer and, eventually, from the first spacer to the next pipette tip carrier.

Details for the load transfer elements are presented in FIG. 14. Starting from the bottom of the illustration: The spacer below the pipette tip carrier provides the protrusion 44 passing through the corner opening 14 of the pipette tip carrier 1 and the top surface 46 of the protrusion 44 abuts the stop surface 45 of the spacer positioned above the pipette tip carrier 1. There is a gap 57 (see FIG. 15) between the two spacers that is available for the pipette tip carrier preventing load transfer to the carrier. The vertical height of the peripheral wall 36 is defined by the distance 48 between the upper rim 40 and the lower rim 42 whereas the height of the load transfer element 43 is defined by the vertical distance 49 between the end of the protrusion 46 and the stop surface 45. The vertical distance 49 exceeds the height 48 of the peripheral wall 36 thereby leaving the gap below the lower rim 42 of each spacer that is available for the pipette tip carrier. Each pipette tip carrier may be placed on the upper rim 40 of a first spacer 34 and a second spacer may be placed on top of the first spacer, and the lower rim 42 of the second spacer will not contact the rectangular skirt 5 surrounding the pipette tip carrier.

Further details for the protrusions 51 of a spacer engaging the top surface of a subjacent spacer are shown in FIG. 15. The protrusions 51 projecting downwards from the longitudinal side of the lower surface 41 of a superjacent spacer 34 abut the upper surface 39 of a subjacent spacer 34 via the opening 11 in the pipette tip carrier 1. The abutment of the protrusions 51 projecting downwards from the transverse sides provide a comparable sectional view with the only difference in that the opening 11 is replaced by the cut-out 55.

The vertical loads applied to a pipette tip carrier may thus be transferred in a stack of spacers and carriers via the load transfer elements 43 on each corner, and/or via the protrusions 51 on the longitudinal sides of the spacer, and/or via the protrusions 51 on the transverse sides of the spacer for a direct spacer-to-spacer load transfer. Optionally a part of the vertical load is transmitted via the central projections 52 for spacer-to-carrier loading.

The spacer 34 includes spring elements 54 on each corner as presented in FIGS. 10, FIG. 15 and FIG. 16. When placing a spacer 34 onto another spacer carrying a pipette tip carrier, then the placement may be accompanied by a shift in the horizontal plane of the one spacer versus the another spacer. The play in the horizontal plane is compensated for or eliminated using the spring elements 54 located on each corner. The spring element 54 protrudes from the bottom surface of the horizontal base 35 towards the lower rim 42 and can flex along the diagonal of the rectangular shaped spacer towards the center or towards the corner of the peripheral wall 36. The spring element 54 of a spacer may have a semi-circular shape for at least partially surrounding the protrusion 44 protruding upwards from of a subjacent spacer. The spring elements of the top spacer on each corner can flex when engaging the protrusions 44 of a subjacent spacer and thereby self-center the spacer with respect to the subjacent spacer and compensate for horizontal misplacement or provide a barrier against twisting the stack of spacers. The twist barrier provides a resilient realignment force when torquing the top of the stack with respect to the bottom of the stack. Reliable pick-up of the pipettes from the carriers depends on the accuracy for the movements of the pipetting robot and on the dimensional tolerances for a stack of the spacers and the pipette tip carriers. The self-centering spring elements may thus reduce the stack-up of tolerances induced by the placements and handling of the spacers and carrier. The flexibility or resilience of the spring element may be tuned by the material used for the spring element 54 and/or the wall thickness of the spring elements and/or the use of a support rib 56 protruding along the back surface of the spring element 54 towards the end of the spring element. The spring element 54 may surround the stop surface 45 on each corner thereby acting as a guiding element guiding the post 44 of a subjacent spacer towards the stop surface of the spacer on top during spacer placement, see FIG. 16.

FIG. 15 furthermore presents the gap 57 between the two spacers 34 that is available for the pipette tip carrier 1 placed between the two spacers. The height of the gap 57 is defined by the difference between the length of the transfer element 49 and the vertical distance 48 between the upper and lower rim of the spacer as presented in FIG. 14. FIG. 14 furthermore presents the spring elements 54 in the longitudinal sectional view engaging the protrusion 44 of a subjacent spacer. The spring elements 54 for guiding and aligning the spacers act during pile-up or stacking of the spacers and pipette tip carriers onto each other, this operational step in the laboratory automation procedure is done before starting the liquid handling procedure with the pick-up, and therewith vertical loading of the stacks. The spacer presented above in combination with the trays therefore allows for a separation of the correct alignment during stacking and an effective transfer of the vertical loads during liquid handling and this in combination with spacers and pipette tip carriers that require less material during manufacturing and have a lower carbon footprint.

The mere fact that certain elements or steps are recited in distinct claims shall not preclude the existence of further meaningful combinations of these elements or steps.

LIST OF REFERENCE SIGNS

| | |
|---|---|
| 1 | Rectangular shaped pipette tip carrier |
| 2 | Disposable pipetting tip |
| 3 | Rectangular shaped top plate |
| 4 | Peripheral wall |
| 5 | Rectangular skirt |
| 6 | Hollow cylinder |
| 7 | Circular opening |
| 8 | Passage |
| 9 | Ribs, connecting ribs |
| 10 | Skirt ribs |
| 11 | Opening |
| 12 | Longitudinal side |
| 13 | Transverse side |
| 14 | Opening, corner opening |
| 15 | Corner rib |
| 16 | Corner peripheral wall |
| 17 | Bottom surface |
| 18 | Bottom wall |
| 19 | Guiding member |
| 20 | Packaging |
| 21 | Peripheral side wall |
| 22 | Longitudinal side |
| 23 | Transverse side |
| 24 | Rectangular shaped box |
| 25 | Top rim |
| 26 | Bottom rim |
| 27 | Protrusion, flap extending from top rim |
| 28 | Protrusion, flap extending from bottom rim |
| 29 | Top cover |
| 30 | Bottom Cover |
| 31 | Closure lid |
| 32 | Pipette collar |
| 33 | Pipette tube |
| 34 | Rectangular spacer |
| 35 | Horizontal base surface |
| 36 | Peripheral side wall |
| 37 | Longitudinal side |
| 38 | Transverse side |
| 39 | Upper surface |
| 40 | Upper rim |
| 41 | Lower surface |
| 42 | Lower rim |
| 43 | Load transfer element |
| 44 | Protrusion |
| 45 | Stop surface |
| 46 | End of protrusion |
| 47 | Rib |
| 48 | Vertical distance upper-lower rim |
| 49 | Length load transfer element |
| 50 | Ledge |
| 51 | Protrusion |
| 52 | Projection |
| 53 | Opening |
| 54 | Spring element |
| 55 | Cut-out |
| 56 | Support rib |
| 57 | Gap |
| 58 | Labelling section |
| 59 | Indentions |
| 60 | Ridge |
| 61 | Gripper pipetting robot |
| 62 | Pipetting head |
| 63 | Slits |
| 64 | Closure flap |
| 65 | Predetermined folding line; predetermined fold |
| 66 | Foldable sheet |
| 67 | Corrugated structure |
| 68 | Pipette box |
| 69 | Stacked pile |
| 70 | Collar adapter |
| 71 | Reinforcement rib |

1. A frame-shaped, essentially rectangular spacer for a rectangular pipette tip carrier, the spacer being configured to be stacked on top of another spacer thereby providing a vertical space between the spacers for the pipette tip carrier, wherein the spacer comprises:
a horizontal base surface,
a peripheral side wall which stands essentially perpendicular to the base surface providing two longitudinal sides and two transverse sides, wherein each longitudinal side and transverse side comprises an inner side connected to the base surface,
the peripheral side wall comprises an upper surface arranged on an upper rim of the peripheral side wall and a lower surface arranged on a lower rim of the peripheral side wall, wherein the upper and lower surfaces extend essentially horizontally, and the upper surface of the peripheral side wall is configured to support the pipette tip carrier,
wherein the spacer comprises load transfer elements configured to transfer a vertical load directly from one spacer to a subjacent spacer.

2. The spacer according to claim 1, wherein the load transfer elements on each spacer comprise protrusions vertically extending from the upper surface on each corner of the spacer and stop surfaces recessed from the lower surface on each corner of the spacer.

3. The spacer according to claim 1, wherein the protrusions and the stop surfaces on each corner of each spacer are vertically aligned with respect to another.

4. The spacer according to claim 3, wherein the stop surfaces of the spacer are configured for abutting the end of the protrusions of a subjacent spacer and wherein the ends of the protrusions of the spacer are configured for abutting the stop surfaces of a superjacent spacer.

5. The spacer according to claim 4, wherein the stop surfaces protrude vertically from the horizontal base surface.

6. The spacer according to claim 5, wherein the stop surface is located at the end of a rib protruding diagonally inwards from each corner.

7. The spacer according to claim 2, wherein the vertical distance between the upper rim and lower rim of the peripheral side wall is below the height of the load transfer element defined by the vertical distance between the end of the protrusion vertically extending from the upper surface and the stop surface on each corner.

8. The spacer according to claim 7, wherein the upper rim of the peripheral side wall comprises ledges for holding and supporting the pipette tip carrier.

9. The spacer according to claim 7, wherein the load transfer elements on each spacer further comprise protrusions vertically extending from the lower rim of the peripheral side wall configured to pass through complementary openings in the pipette tip carrier, the end of the protrusions are configured to abut an upper surface of the peripheral side wall of a subjacent spacer.

10. The spacer according to claim 7, wherein the horizontal base surface comprises a projection located at the center of the rectangular spacer which protrudes vertically towards the upper rim of the peripheral side wall and protrudes vertically towards the lower rim of the peripheral side wall and the top surface of the projection is configured to abut a pipette tip carrier positioned on top of the spacer and the bottom surface of the projection is configured to abut a pipette tip carrier positioned below the spacer.

11. The spacer according to claim 7, wherein the horizontal base surface comprises a plurality of openings oriented according to a pattern complementary to a pattern of pipette bores for holding pipette tips in the pipette tip carrier.

12. The spacer according to claim 7, further comprising centering spring elements at each corner and wherein the centering spring elements are configured to act upon the protrusions on each corner of a subjacent spacer on which the spacer is positioned with horizontal and/or vertical play thereby acting as a centering aid or as a twist barrier in a stack of the spacer and the subjacent spacer.

13. The spacer according to claim 12, wherein the centering spring elements at each corner at least partially surround the stop surfaces.

14. The spacer according to claim 13, wherein the spring elements are configured to at least partially surround the protrusions on each corner of a subjacent placed spacer.

15. The spacer according to claim 14, wherein the spring element extends vertically wherein one end of the spring element is attached or attachable to the bottom of the horizontal base surface and the other end is configured to flex along the diagonal of the rectangular spacer.

16. The spacer according to claim 15, wherein the spring elements are shaped as half shells, with a radius adapted to engage the outer radius of a cylindrically shaped protrusion of a subjacent spacer when the spacer is positioned on top of the subjacent spacer thereby elastically deforming the spring element.

17. A frame-shaped, essentially rectangular spacer for a rectangular pipette tip carrier, the spacer being configured to be stacked on top of another spacer thereby providing a vertical space between the spacers for the pipette tip carrier, wherein the spacer comprises:
a horizontal base surface,
a peripheral side wall which stands essentially perpendicular to the base surface providing two longitudinal sides and two transverse sides, wherein each longitudinal side and transverse side comprises an inner side connected to the base surface,
the peripheral side wall comprises an upper surface arranged on an upper rim of the peripheral side wall and a lower surface arranged on a lower rim of the peripheral side wall, wherein the upper and lower surfaces extend essentially horizontally, and the upper surface of the peripheral side wall is configured to support the pipette tip carrier,
wherein the spacer comprises load transfer elements configured to transfer a vertical load directly from one spacer to a subjacent spacer, wherein the load transfer elements on each spacer comprise protrusions vertically extending from the upper surface on each corner of the spacer and stop surfaces recessed from the lower surface on each corner of the spacer and the spacer further comprising centering spring elements at each corner and wherein the centering spring elements are configured to act upon the protrusions on each corner of a subjacent spacer on which the spacer is positioned with horizontal and/or vertical play thereby acting as a centering aid or as a twist barrier in a stack of the spacer and the subjacent spacer.

18. The spacer according to claim 17, wherein the centering spring elements at each corner at least partially surround the stop surfaces and wherein the spring elements are configured to at least partially surround the protrusions on each corner of a subjacent placed spacer.

19. The spacer according to claim 18, wherein the vertical distance between the upper rim and lower rim of the peripheral side wall is below the height of the load transfer element defined by the vertical distance between the end of the protrusion vertically extending from the upper surface and the stop surface on each corner.

20. An assembly comprising a stack of at least two frame-shaped spacers according to claim 1 and a rectangular pipette tip carrier positioned between the two spacers wherein the pipette tip carrier comprises a plate comprising:
a lower surface for engaging the upper surface of a subjacent spacer,
a plurality of pipette bores for holding pipette tips,
corner openings on each corner of the plate fitting onto the protrusions of the subjacent spacer,
openings providing a passage for the protrusions vertically extending from the lower rim of the peripheral side wall of a superjacent spacer, the end of the protrusions vertically extending from the lower rim are configured to abut the upper rim of the peripheral side wall of the subjacent spacer.
